(19) United States
(12) Patent Application Publication
(10) Pub. No.: US 2020/0126009 A1
(43) Pub. Date: Apr. 23, 2020

(54) METHOD AND DEVICE FOR EVALUATING RISK OF A BUSINESS DATA TABLE CORRECTION, AND STORAGE MEDIUM

(71) Applicant: Ping An Technology (Shenzhen) Co., Ltd., Shenzhen, Guandong (CN)

(72) Inventor: Zongtao Fu, Shenzhen, Guangdong (CN)

(21) Appl. No.: 16/307,952

(22) PCT Filed: Sep. 27, 2017
(86) PCT No.: PCT/CN2017/103575

§ 371 Date: Dec. 7, 2018

(30) Foreign Application Priority Data
Jun. 21, 2017 (CN) 201710477717.9

(51) Int. Cl. G06Q 10/06; G06F 16/23; G06F 16/25

(52) U.S. Cl. CPC G06Q 10/0635; G06F 16/258; G06F 16/2365

(57) ABSTRACT

Disclosed are a method and a device for evaluating a risk of a business data table correction, as well as a computer-readable storage medium. The method includes: obtaining an original datum in a business data table, a corrected datum obtained by correcting the original datum, and a characteristic parameter of the corrected datum; converting the original datum, the corrected datum, and the characteristic parameter according to a preset conversion method to obtain a correction risk; and determining a risk level of the business data table correction based on the correction risk, and issuing a corresponding alert message according to the risk level.

The present application claims priority to Chinese Patent Application No. 201710477717.9, filed on Jun. 21, 2017 with the State Intellectual Property Office and entitled “Method and Device for Evaluating Risk of a Business Data Table Correction, and Storage Medium”, the entirety of which is hereby incorporated herein by reference.

### TECHNICAL FIELD

This disclosure relates generally to the technical field of business data processing, and more particularly relates to a method and a device for evaluating a risk of a business data table correction, as well as a storage medium.

### BACKGROUND

Business data used by an application system are currently obtained by extracting data in an upstream data table and then converting the extracted data. Due to the absence of some fields in the upstream data table or some data conversion failures or other accidental factors that may be existent during the conversion process, the business data may not meet the requirements of the application system or may be displayed in error. In this case, such data that don't meet the requirements or are displayed in error would need to be corrected, and the corrected result won't go through the extraction and conversion process once again but instead will be directly used as the final business data. However, the correcting process may be subject to operational errors, such as a decimal point error, a unit system misalignment, etc., or the fact that the correction-related data are not considered may lead to situations in which an articulation is no longer satisfied after the correction. If the misoperated data are stored and used as the business data, it is likely to cause problems in the business data used by the application system.

### SUMMARY

It is therefore a primary object of the present disclosure to provide a method and a device for evaluating a risk of a business data table correction as well as a computer-readable storage medium, which are intended to solve the problem in the prior art where the misoperated data are saved and used as the business data leading to an error in the business data of the application system.

To achieve the above object, this disclosure provides a method for evaluating a risk of a business data table correction. The method including the following operations: obtaining an original datum in a business data table, a corrected datum obtained by correcting the original datum, and a characteristic parameter of the corrected datum; converting the original datum, the corrected datum, and the characteristic parameter according to a preset conversion method to obtain a correction risk; and determining a risk level of the business data table correction based on the correction risk, and issuing a corresponding alert message according to the risk level.

In addition, in order to achieve the above object, this disclosure further provides a device for evaluating a risk of a business data table correction, the device including a memory, a processor, a communication bus, and a business data table correction risk evaluating program that is stored in the memory. The communication bus is configured to facilitate the connection and communication between the processor and the memory. The processor is configured to execute the business data table correction risk evaluating program to perform the following operations: obtaining an original datum in a business data table, a corrected datum obtained by correcting the original datum, and a characteristic parameter of the corrected datum; converting the original datum, the corrected datum, and the characteristic parameter according to a preset conversion method to obtain a correction risk; and determining a risk level of the business data table correction based on the correction risk, and issuing a corresponding alert message according to the risk level.

Further, in order to achieve the above object, this disclosure further provides a computer-readable storage medium storing one or more programs, where the one or more programs can be executed by one or more processors to perform the following operations: obtaining an original datum in a business data table, a corrected datum obtained by correcting the original datum, and a characteristic parameter of the corrected datum; converting the original datum, the corrected datum, and the characteristic parameter according to a preset conversion method to obtain a correction risk; and determining a risk level of the business data table correction based on the correction risk, and issuing a corresponding alert message according to the risk level.

According to the method and device for evaluating a risk of a business data table correction as well as the computer-readable storage medium that are provided by the embodiments disclosed herein, an original datum in a business data table, a corrected datum obtained by correcting the original datum, and a characteristic parameter of the corrected datum are first obtained. Then the original datum, the corrected datum, and the characteristic parameter are converted according to a preset conversion method to obtain a correction risk. Further a risk level of the business data table correction is determined based on the correction risk, and a corresponding alert message is issued according to the risk level so as to remind that there may be an error in the corrected datum obtained by correcting the original datum and that using this corrected datum as the business data of the application system can render the business data of the application system problematic. Different alert messages may be issued for different risk levels, so that the data correcting personnel can perform different operations according to different alert messages, so as to avoid saving the erroneous corrected data as the business data for future use.

### BRIEF DESCRIPTION OF THE ACCOMPANYING DRAWINGS

FIG. 1 is a flowchart illustrating a first embodiment of a method for evaluating a risk of a business data table correction in accordance with this disclosure.

FIG. 2 is a flowchart illustrating a second embodiment of a method for evaluating a risk of a business data table correction in accordance with this disclosure.

FIG. 3 is a flowchart illustrating a third embodiment of a method for evaluating a risk of a business data table correction in accordance with this disclosure.

FIG. 4 is a flowchart illustrating a fourth embodiment of a method for evaluating a risk of a business data table correction in accordance with this disclosure.

FIG. 5 is a schematic diagram illustrating device structure in terms of hardware operating environment involved in the methods according to the embodiments of this disclosure.

Various implementations for realizing the objects, functional features, and advantages of this disclosure will now be described in further detail in connection with embodiments and the accompanying drawings.

### DETAILED DESCRIPTION OF ILLUSTRATIVE EMBODIMENTS

It will be appreciated that the specific embodiments described herein are merely illustrative of the present disclosure and are not intended to limit the disclosure.

This disclosure provides a method for evaluating a risk of a business data table correction.

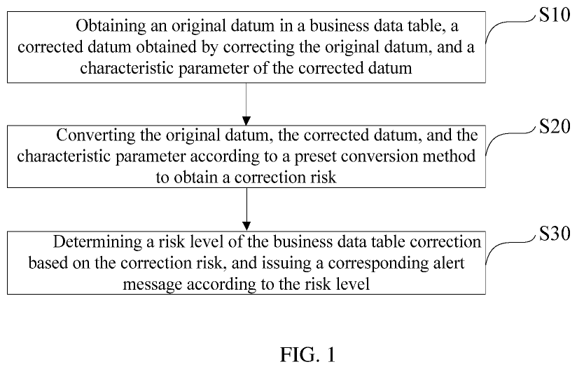

Referring to FIG. 1, there is depicted a flowchart illustrating a first embodiment of a method for evaluating a risk of a business data table correction in accordance with this disclosure. In this embodiment, the method includes the following blocks S10 to S30.

In S10, the method includes: obtaining an original datum in a business data table, a corrected datum obtained by correcting the original datum, and a characteristic parameter of the corrected datum.

Currently, business data tables of an application system include an account information table, a basic data table, and a core data table. The business data in a business data table is obtained by extracting the data in an upstream data table and then converting the extracted data. The upstream data table serves as a source of data and contains a large amount of data. However, due to the lack of some fields in the upstream data table or some data conversion failures or other accidental factors that may be existent during the conversion process, the converted business data may not meet the requirements of the application system or may be displayed in error. In this case, such data that does not meet the requirements or is displayed in error would need to be corrected. In this embodiment, a datum that is extracted from the upstream data table and then converted and that does not meet the requirements of the application system or is displayed in error is used as an original datum in the business data table, while a datum that is obtained by correcting this original datum which doesn't meet the requirements of the application system or is displayed in error is used as a corrected datum. A corrected datum has a characteristic parameter, which is used to indicate an impact on the business data table after the original datum is modified as the corrected datum. The characteristic parameter of the corrected datum includes a number of uncorrected data affected by the corrected datum, the fact whether the corrected datum is a core datum, and the fact whether the corrected datum needs to be delivered to another system.

It will be appreciated that a datum in the application system doesn't exist separately; it may be related to other data in the application system. As such, a correction on an original datum that doesn't meet the requirements of the application system or that is displayed in error may have an impact on the interrelationships of the corrected datum with other uncorrected data. When different original data in the business data table are corrected, or when a same original datum is corrected in different ways, the number of interrelationships affected may also be different. More specifically, the number of other uncorrected data affected by the corrected datum can be obtained by means of detection. First, ascertain the interrelationships of each datum in the business data table with other data. Then when a certain datum is corrected, then detect whether the corrected datum still satisfies the pre-correction interrelationships with the other data. When an interrelationship is not satisfied, the number of unsatisfied statistics is counted. This number of the unsatisfied is the number of uncorrected data affected by the corrected datum. For example, assume the number of interrelationships between an original datum P and other data in the business data table is 5, while the number of interrelationships between another original datum Q and the other data in the business data table is 3. Then a correction is made on original datum P, after which two of the interrelationships thereof are no longer satisfied. That means the correction has an impact on two interrelationships in the business data table. Similarly, a correction is made on datum Q, after which one interrelationship is no longer satisfied; that is, the correction has an impact on one interrelationship in the business data table. A correction on a different original datum may entail a different number of its interrelationships with other uncorrected data being affected. This number of its interrelationships with the uncorrected data that are affected is one of the characteristic parameters of this corrected datum. For example, one of the characteristic parameters of the datum P as described above is n, and one of the characteristic parameters of the datum Q is m.

In addition, different data represent different information in the business data table, such as a client information datum that indicates the age of a client, a capital datum that indicate the inflow or outflow of a client's funds, and so on. Obviously, the capital datum plays a more important role in the business data table than the client information datum, so that this datum which plays an important role would be taken as a core datum. When modifying a core datum, the modified datum would have a relatively great impact on the business data table. Thus, in this embodiment, a parameter with a value greater than one is set, and a result of determining whether a datum is a core datum is taken as an exponent of this parameter. When the result of the determination indicates positive on core datum, the exponent would assume the value 1, such that the parameter to the power of the exponent would equal the value of the parameter itself. Otherwise when the result of the determination indicates negative on core datum, the exponent would take the value 0, such that the parameter to the power of the exponent would equal 1. Meanwhile, there may exist connections between different business data tables, and a modified datum in the business data table may be sent to the business data table of another system for processing. When the modified datum needs to be sent to the business data table of another system, it indicates that this datum is a key datum and that after this datum is modified the modified datum may have an impact on both the local business data table and the business data table to which it is sent. Likewise, a parameter greater than one is also set, and the result of determining whether a datum needs to be delivered to another system is taken as an exponent of this parameter. When the result of the determination points to the fact that it needs to be delivered to another system, then the exponent would take the value 1, such that the parameter to the power of the exponent would equal the value of the parameter itself. Otherwise when the result of the determination points to the fact that it need not be delivered to another system, then the exponent would take the value 0, and so the parameter to the power of this exponent would equal 1. By taking the fact whether a datum is a core datum and whether the datum would be delivered to another system as one of the characteristic parameters of a corrected datum, the magnitude of the impact of a datum correction on the business data table can be reflected. Thus, the number of uncorrected data affected by the corrected datum, the fact whether the corrected datum is a core datum, and the fact whether the corrected datum needs to be delivered to another system are taken as the characteristic parameters of this corrected datum. On basis of this, an original datum in the business data table, a corrected datum obtained after the original datum is corrected, as well as the characteristic parameters of the corrected datum are obtained, so as to determine a risk level after the correction. The method then continues to block S20.

In S20, the method includes: converting the original datum, the corrected datum, and the characteristic parameter according to a preset conversion method to obtain a correction risk.

Further, after obtaining the original datum in the business data table, the corrected datum corresponding to the original datum as well as the corresponding characteristic parameters of the corrected datum, they are converted according to a preset conversion method to obtain a correction risk. The preset conversion method may be a preset function formula, and the specific function formula is as shown in the following formula (1):

$$risk = w 1 * [ abs ( ln ( \frac{{V}_{current}}{{V}_{before}} ) ) + abs ( ln ( \frac{{V}_{current}}{V} ) ) ] * n * {w}_{2}^{b 1} * {{w}_{3}^{b 2}}^{ } \qquad ( 1 )$$

where risk represents the correction risk, abs denotes taking an absolute value, In represents taking a natural logarithm, wᵢ (i=1, 2, 3) denotes three coefficients, V_{current} denotes a currently corrected datum, V_{before} denotes the previously corrected datum, V denotes an original datum, n denotes a characteristic parameter indicative of the number of uncorrected data affected, b₁ indicates the fact whether the corrected datum needs to be delivered to another system, and b₂ indicates the fact whether the corrected datum is a core datum. The original datum, the corrected datum, and the characteristic parameters serve as the independent variables of the function formula, while the correction risk serves as the dependent variable of the function formula. Substituting the independent variables into the function formula, the obtained dependent variable of the function formula is the correction risk, which is used to represent the degree of risk associated with the business data table that is triggered by this corrective operation. The method then proceeds to block S30.

In S30, the method includes: determining a risk level of the business data table correction based on the correction risk, and issuing a corresponding alert message according to the risk level.

Still further, after the correction risk is calculated according to the preset conversion method, this risk is used to indicate the risk degree of the business data table that is triggered by the corrective operation, and is further based on to determine a risk level of the business data table correction, and then a corresponding alert message is issued according to the risk level. It will be appreciated that when the corrected datum is a capital datum indicating the inflow and outflow of the client's funds, namely a core datum, then if an operational error occurs during the corrective operation, it may have a relatively great impact on the business data table, and so the corrected datum obtained by the corrective operation has a high risk level. Otherwise if the corrected datum post correction is not a capital datum indicative of the inflow and outflow of funds or it need not be delivered to another system, then an operational error that may occur during the corrective operation may have a relatively small impact on the business data table, and so the corrected datum obtained by the corrective operation has a low risk level. By the magnitude of the correction risk reflecting the magnitude of the impact on the business data table, the risk level is determined. The greater the impact, the greater the potential threat posed out of correcting the original datum, namely the higher the risk level; a corresponding alert message is then issued according to this risk level. To reflect different risk levels, there may be different alert messages. When the risk level is low, a low warning message may be issued to attract the attention of the correcting personnel, while when the risk level is high, a high warning message may be issued to cause the correcting personnel to pay particular attention. In this way, the saving of a corrected datum with a high risk for use as a datum in the business data table can be avoided, and so the accuracy of the business data of the application system can be improved.

According to the method for evaluating a risk of a business data table correction provided by this embodiment, an original datum in a business data table, a corrected datum obtained by correcting the original datum, and a characteristic parameter of the corrected datum are first obtained. Then the original datum, the corrected datum, and the characteristic parameter are converted according to a preset conversion method to obtain a correction risk. Further a risk level of the business data table correction is determined based on the correction risk, and a corresponding alert message is issued according to the risk level so as to remind that there may be an error in the corrected datum obtained by correcting the original datum and that using this corrected datum as the business data of the application system can render the business data of the application system problematic. A corresponding different alert messages may be issued for a different risk level, so that the data correcting personnel can perform different operations according to different alert messages, so as to avoid the use of this erroneous corrected datum as the business data of the application system. Therefore, the accuracy of the business data of the application system is improved.

Further, in another embodiment of the method for evaluating a risk of a business data table correction in accordance with the present disclosure, block S10 “obtaining an original datum in a business data table, a corrected datum obtained by correcting the original datum, and a characteristic parameter of the corrected datum” includes the following operations S11 to S13.

In S11, the block includes: obtaining a currently corrected datum that results from a current corrective operation on the original datum, and a previously corrected datum that results from a previous corrective operation on the original datum.

In S12, the block includes: after the original datum is corrected as the currently corrected datum, obtaining a number of cells of cell data in the business data table that don't satisfy articulations.

In S13, the block includes: obtaining a first parameter used to identify whether the currently corrected datum is to be delivered to a downstream system, a second parameter used to identify whether the currently corrected datum is a core data table datum, where the number of cells, the first parameter, and the second parameter are used as the characteristic parameters of the currently corrected datum.

It will be understood that after an original datum has been corrected for the first time to obtain a corrected datum, this original datum, corrected datum, and the characteristic parameters of the corrected datum can be used to original datum a correction risk. The correction risk can further be based on to determine a risk level. When the risk level is high, a re-correction needs to be performed based on the reason why the risk level is high, namely based on the corrected datum the results from the first correction, and this corrected datum that results from the re-correction is based on to obtain the risk level once again. Both the corrected datum resulting from the re-correction and the corrected datum resulting from the first correction are related to the original datum. Further, when the risk level determined based on the corrected datum that results from the re-correction is still high, then another correction needs to be performed on the basis of the corrected datum resulting from the re-correction. Because the corrected datum resulting from each correction is related to both the corrected datum resulting from the previous correction and to the uncorrected original datum, this solution obtains the currently corrected datum that results from the current corrective operation on the original datum as well as the previously corrected datum that results from the previous corrective operation on the original datum.

In addition, because the data in the application system does not exist separately and there exist restrictive relationships between the data, this solution uses articulations to represent the inherent logical correspondences between the data. An articulation refers to a relationship that can be mutually checked and verified, such as greater than, less than, various function relations and the like; that is, one cell datum corresponds to one articulation. When an original datum is corrected to obtain a currently corrected datum, its restrictive relationships with other data may be rendered no longer satisfied so that the logical relationships that can be used for check and verification between data no longer correspond. For example, assume a correction is to be performed on a datum D, which satisfies the following articulations before the correction: D=A+B, D=k*E, and D>F, where A, B, E, and F are other data in the business data table, and k is a coefficient. After the correction is made on D, it doesn't satisfy the articulations D=A+B and D=k*E, so that the restrictive relationships of the corrected datum D with the data A, B, and E are no longer satisfied, and the logical relationships that can be used for check and verification between data don't correspond, and the number of non-correspondences is two. Thus, the number of non-correspondences between the data in the business data table that result from the correction on the original datum, namely the number of cells of the cell data that don't satisfy the articulations, is obtained, so as to determine the impact on the entire business data table after the original datum is corrected as the currently corrected datum. The greater the number cells, the greater the impact on the entire business data table post the correction on the original datum, and the higher the risk level posed by the corrected datum. In addition, a datum in the business data table may need to be delivered to a downstream system for use by the downstream system. In this case, the datum that needs to be delivered would be an important datum, so that a correction on this datum may affect the data of the downstream system and thus would have a relatively great impact on the risk level. The first parameter is used to identify whether the currently corrected datum needs to be delivered to the downstream system. When it needs to be delivered, the first parameter is true, namely the first parameter takes the value 1; otherwise when it need not be delivered, then the first parameter is false, namely the first parameter takes the value 0. Further, the original datum that is corrected may be a datum in a core data table. Accordingly, the currently corrected datum obtained by correcting the original datum would also be a datum in the core data table. The core data table is an important data table in the application system. Correcting the data therein may affect the important data in the application system and so may have a great impact on the risk level. The second parameter is used to identify whether the currently corrected datum is a core data table datum. When it is a datum in the core data table, the second parameter is true, namely the second parameter takes the value 1; otherwise when it isn't a datum in the core data table, the second parameter is false, i.e., the second parameter takes the value 0. According to this solution, the number of the cells that don't satisfy the articulations, the first parameter, and the second parameter are taken as the characteristic parameters of the currently corrected datum. Thus, the characteristic parameters are obtained, and the risk level resulting from the correction is then determined by conversion based on the characteristic parameters, the original datum, the currently corrected datum, and the previously corrected datum.

Further, in another embodiment of the method for evaluating a risk of a business data table correction in accordance with the present disclosure, block S20 of “converting the original datum, the corrected datum, and the characteristic parameter according to a preset conversion method to obtain a correction risk” includes the following operations S21 to S23.

In S21, the block includes: obtaining a first differential datum between the currently corrected datum and the original datum and a second differential datum between the currently corrected datum and the previously corrected datum, and taking the first differential datum and the second differential datum as a differential coefficient.

In S22, the block includes: obtaining an adjustment coefficient for the differential coefficient based on the number of cells, the first parameter, and the second parameter.

In S23, the block includes: obtaining the correction risk based on the differential coefficient and the adjustment coefficient.

Further, the correction risk is obtained by converting the original datum, the corrected datum, and the characteristic parameter according to the preset conversion method, where the preset conversion method is a function relational formula as illustrated in formula (1). In the formula (1) of this embodiment, n represents the number that does not satisfy the articulations, b₁ represents the first parameter, and b₂ represents the second parameter. After the original datum V, the currently corrected datum V_{current} resulting from the current corrective operation on the original datum, as well as the previously corrected datum V_{before} resulting from the previous corrective operation performed on the original datum that comes prior to the current corrective operation have been obtained, the first differential datum between the obtained currently corrected datum V_{current} and the original datum V together with the second differential datum between the currently corrected datum V_{current} and the previously corrected datum V_{before} are obtained and are taken as the differential coefficient. The differential datum can be expressed as a quotient value or by a difference value, where the greater the quotient value or the difference value, the greater the difference between the two; on the contrary, the smaller the quotient value or the difference value, the smaller the difference between the two. In this function relational formula, it is expressed as a quotient value. More specifically, the quotient obtained by dividing the currently corrected datum V_{current} by the previously corrected datum V_{before} is taken as the real number of the natural logarithm, and then an absolute value is taken for the natural logarithm—the obtained value is the first differential datum. Likewise, the quotient obtained by dividing the currently corrected datum V_{current} by the original datum V is taken as the real number of the natural logarithm, an absolute value is then taken to obtain a value which is the second differential datum. The magnitude of the first differential datum can indicate the size of the difference between the currently corrected datum and the original datum. The greater the datum, the greater the difference between the currently corrected datum and the original datum, and the greater the range of the historical correction; otherwise the smaller the difference, and the smaller the range of the historical correction. The magnitude of the second differential datum can indicate the size of the difference between the currently corrected datum and the previously corrected datum. The greater the datum, the greater the difference between the currently corrected datum and the previously corrected datum, and the greater the range of the previous correction; otherwise the smaller the difference, and the smaller the range of the previous correction. Further, a sum obtained by adding the first differential datum and the second differential datum together is taken as the differential coefficient. The greater the differential coefficient, the greater the difference between the currently corrected datum post-correction and the original datum.

After obtaining the differential coefficient used to indicate the size of the difference between the currently corrected datum and the original datum, the differential coefficient needs to be further adjusted based on the characteristic parameters of the currently corrected datum. More specifically, when the characteristic parameters indicate that the number of cells of the cell data that don't satisfy the articulations caused by the currently corrected datum is large, and that the currently corrected datum is a core datum that needs to be delivered to a downstream system, then it means that the currently modified datum has a great impact on the business data table—in this case, the differential coefficient thereof is enlarged; otherwise it would be reduced. After obtaining the number n of cells of the cell data that don't satisfy the articulations in the business data table, the first parameter b₁ that identifies whether the currently corrected datum is to be delivered to the downstream system, as well as the second parameter b₂ that identifies whether the currently corrected datum is a core data table datum, the adjustment coefficient for the differential coefficient is obtained based on the number n that don't satisfy the articulations, the first parameter b₁, b₂ and the second parameter. More specifically, the first parameter b₁ is taken as an exponent of a second coefficient w₂ to obtain a second coefficient value, the second parameter b₂ is taken as an exponent of a third coefficient w₃ to obtain a third coefficient value. Then the second coefficient value, the third coefficient value, and the number n of cells are multiplied together to obtain a product, which is taken as the adjustment coefficient for the differential coefficient. Therefore, the risk can be obtained based on the differential coefficient and the adjustment coefficient, where the differential coefficient, the adjustment coefficient, and the first coefficient w₁ are multiplied together to obtain the correction risk.

In another embodiment of the method for evaluating a risk of a business data table correction in accordance with the present disclosure, block S30 of “determining a risk level of the business data table correction based on the correction risk, and issuing a corresponding alert message according to the risk level” includes the following operations S31 and S32.

In S31, the block includes: determining the risk level of the business data table correction based on a value of the correction risk.

In S32, the block includes: displaying the value of the correction risk correspondingly with the risk level of the business data table correction, and issuing an alert message corresponding to the risk level.

Further, different corrected data may lead to different risk levels. In order to indicate the level of the risk, this embodiment sets multiple risk levels based on different data ranges. Thus, the risk level is determined based on the range in which the value of the correction risk lies. The risk levels can be divided into the following five levels: high, relatively high, medium, relatively low, and low. When the correction risk has a value greater than rv1, then the risk level is high; when the correction risk has a value that is greater than rv2 and less than rv1, then the risk level is relatively high; when the correction risk has a value that is greater than rv3 and less than rv2, then the risk level is medium; when the correction risk has a value that is greater than rv4 and less than rv3, then the risk level is relatively low; when the correction risk has a value less than rv4, then the risk is low, where the rv1, rv2, rv3, rv4, and rv5 satisfy the following relationship in terms of magnitude: rv1>rv2>rv3>rv4>rv5. Therefore, based on the specific value range between the rv1 and rv5 in which the value of the correction risk lies, the risk level can be determined. Further, the value of the correction risk and the risk level of correcting the based on are displayed correspondingly, and an alert message corresponding to the risk level is issued. According to this solution, different alert messages are set for different risk levels, where a lower level corresponds to a lower alert message, and as the level increases, the warning degree of the corresponding alert message would also increase to strengthen the warning function. Specifically, at the low risk level, the alert message is a flashing green light. At the relatively low level, the alert message is a flashing yellow light. At the medium level, the alert message is a steady yellow light. At the relatively high level, the alert message is a flashing red light. At the high level, the alert message is a steady red light. In this way, different risk levels can be distinguished from one another. In addition, voice notifications can also be used, which are not limited herein. In one embodiment, when the value of the correction risk lies between rv3 and rv2, it indicates that the risk level is medium. Accordingly, the value of the correction risk is displayed correspondingly with the risk level, and a steady yellow light is displayed, so as to remind the correcting person to pay attention to correction risk. Thus, the correcting person can very clearly learn the value of the correction risk as well as the risk level.

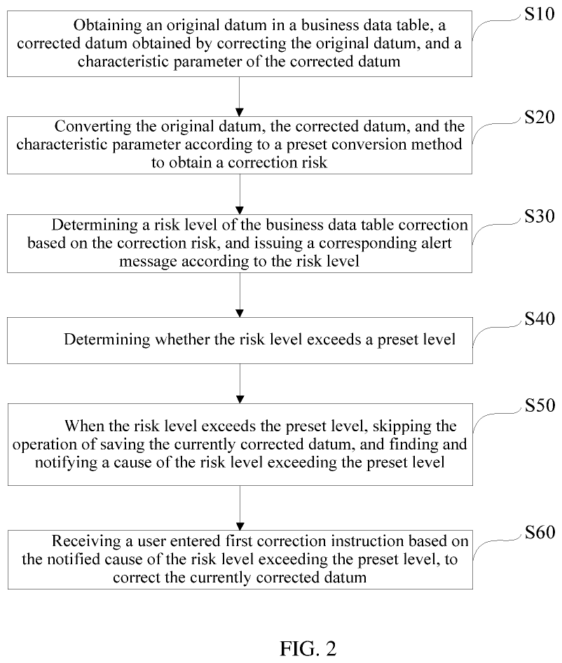

Referring now to FIG. 2, there is depicted a flowchart illustrating a second embodiment of a method for evaluating a risk of a business data table correction in accordance with this disclosure. The second embodiment according to this disclosure is proposed on the basis of the first embodiment of the method for evaluating a risk of a business data table correction in accordance with this disclosure.

In this embodiment, the method further includes the following blocks S40 and S50 subsequent to the block of “determining a risk level of the business data table correction based on a value of the correction risk”.

In S40, the method includes: determining whether the risk level exceeds a preset level.

In S50, when the risk level exceeds the preset level, then the currently corrected datum cannot be saved, and the reason why the risk level exceeds the preset level is found and notified.

The solution of this disclosure further sets a preset level. The preset level indicates that the risk level posed by the corrected datum is relatively high, so that the system may be subjected to a relatively great impact when the preset level is exceeded. After the risk level of the business data table correction is ascertained, a determination is further performed as to whether the risk level exceeds a preset level. When the risk level exceeds the preset level, it indicates that the currently corrected datum poses a relatively high risk level. More specifically, it indicates that the currently corrected datum may have a relatively greater pertinence with other data such that the correction may lead to a relatively large number of cells of the cell data that don't satisfy the articulations, or it indicates that the currently corrected datum needs to be delivered to a downstream system and is a datum in a core data table. At this point, if this currently corrected datum that poses a high risk level is saved for use, then other major problems may be in store. When the currently corrected datum needs to be delivered to the downstream system, the data of the downstream system may be rendered problematic. Therefore, when the risk level exceeds the preset level, the currently corrected datum cannot be saved. That is, this currently corrected datum can neither be saved to the local business data table for use, nor be delivered to the downstream system. Meanwhile, the cause of the risk level exceeding the preset level would be investigated, namely investigate the case of the high risk level. A high risk level indicates that the correction risk obtained by converting the original datum, the corrected datum, and the characteristic parameter according to the preset conversion method has a large value. As such, the cause of the correction risk having a large value is then investigated, whether it be a large unit word correction thus leading to a large currently corrected datum hence the correction risk with a large value, or an exceedingly large number of cells of the cell data that don't satisfy the articulations thus leading to the correction risk with a large value. In addition, the cause of the high correction risk (i.e., the cause of the high risk level) is notified.

Further, the method includes the following block S60 subsequent to the block of “finding and notifying the cause of the risk level exceeding the preset level”.

In S60, the method includes: receiving a user entered first correction instruction based on the notified cause of the risk level exceeding the preset level, to correct the currently corrected datum.

After finding the specific cause of the high risk level, such as a large unit word correction or a large number of cells, this cause is notified in the form of a displayed dialog box. Based on this notified cause, the first correction instruction that is entered by the correcting person and that corresponds to the notified cause is received in order to correct the currently corrected datum. For example, when the correcting person is notified of a large unit word correction, then the amplitude of the unit word correction is reduced. Thus, the first correction instruction is received to further correct the currently corrected datum, and then the corrected datum that has been further corrected is taken as the currently corrected datum, while the previous corrected datum is taken as the previously corrected datum. Then this new currently corrected datum, the previously corrected datum, as well as the characteristic parameters of the currently corrected datum are converted according to the preset conversion method to obtain the correction risk. The correction risk is further based on to determine the risk level so as to further determine whether this currently corrected datum satisfies the risk level requirements.

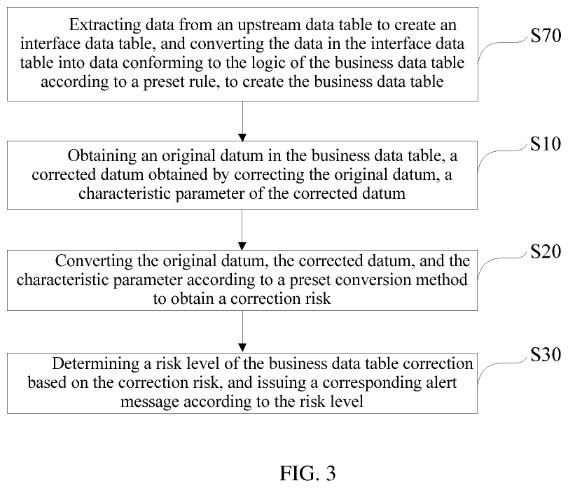

Referring now to FIG. 3, there is depicted a flowchart illustrating a third embodiment of a method for evaluating a risk of a business data table correction in accordance with this disclosure. The third embodiment according to this disclosure is proposed on the basis of the second embodiment of the method for evaluating a risk of a business data table correction in accordance with this disclosure.

In this embodiment, the method further includes the following block S70 prior to the block of “obtaining an original datum in a business data table, a corrected datum obtained by correcting the original datum, and a characteristic parameter of the corrected datum”.

In S70, the method includes: extracting data from an upstream data table to create an interface data table, and converting the data in the interface data table into data conforming to the logic of the business data table according to a preset rule, to create the business data table.

Typically, in this solution the data in the business data table are extracted from the upstream data table and then converted. The upstream data table serves as a source of the data and contains a large amount of complete data. For example, assume a corporate group A includes subordinate companies a, b, and c, then the information data general table of all employees of corporate group A can serve as the upstream data, and so the employee information data table of company a can be created by extracting from the information data general table of all the employees the information data that belong to the employees of company a. Because the logical relationships of the data in the upstream data table are not consistent with those in the business data table, the data extracted from the upstream data table cannot be directly used as the data in the business data table, but need to be converted into logical data that match the logic in the business data table through certain business rules and logic. Thus, the interface data table is created by extracting data from the upstream data table, and the data in the interface data table are converted to the data in the business data table according to the preset rule. The data in the interface data table can be completely the same as the data in the upstream data table. Alternatively, only part of the data in the upstream data table can be extracted, and the data in the interface data table can be converted into the data that match the logic of the business data table according to the preset rule. As in the above embodiment, assume an employee x participates in the bonus distribution in both company a and company b, and the bonus distribution in company b is determined by multiplying the bonus value in company a by a coefficient, then the bonus value of employee x present in the employee information data table of company a would need to be multiplied by the coefficient and then delivered to company b to form the employee information data table of company b. This multiplication logic is the preset rule. The preset rule is a conversion rule that is set in advance, and the data in the business data table can be converted from not only one interface data table. That is, multiple interface data tables can be extracted from several upstream data tables, and then the data in these multiple data tables would be converted to the data that match the logic of the business data table according to the preset conversion rule, thus creating the business data table.

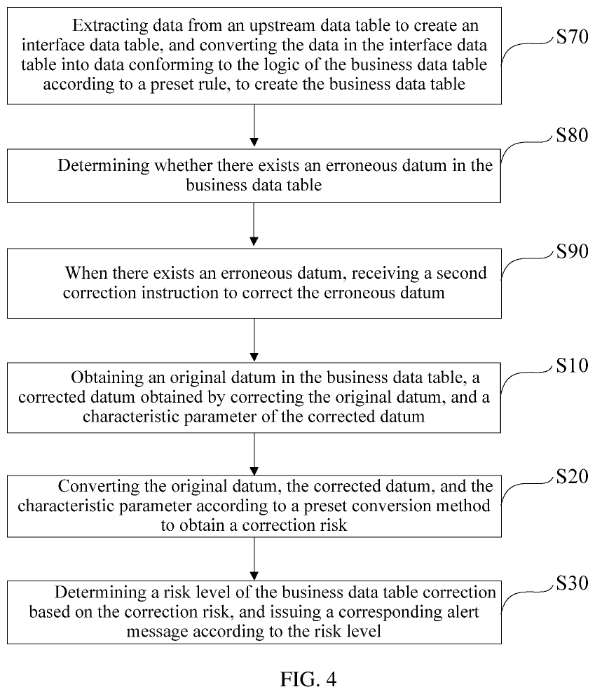

Referring now to FIG. 4, there is depicted a flowchart illustrating a fourth embodiment of a method for evaluating a risk of a business data table correction in accordance with this disclosure. The fourth embodiment according to this disclosure is proposed on the basis of the third embodiment of the method for evaluating a risk of a business data table correction in accordance with this disclosure.

In this embodiment, the method further includes the following blocks S80 and S90 subsequent to the block of “extracting data from an upstream data table to create an interface data table, and converting the data in the interface data table into data conforming to the logic of the business data table according to a preset rule, to create the business data table”.

In S80, the method includes: determining whether there exists an erroneous datum in the business data table.

In S90, the method includes: when there exists an erroneous datum, receiving a second correction instruction to correct the erroneous datum.

Further, after the business data table is created, it is determined whether there exists an erroneous datum in the business data table. Because the data in the business data table are extracted and converted from the upstream data table, the converted business data table may contain data that don't meet the requirements of the application system or may be displayed in error, due to the lack of some fields in the upstream data table or some data conversion failures or other accidental factors that may be existent during the conversion process. In this case, such erroneous data need to corrected. Accordingly, a second correction instruction is received to correct the erroneous datum in order to make it satisfy the requirements of the application system.

It should be noted that those having ordinary skill in the art will appreciate that some or all steps of the foregoing embodiments can be implemented by hardware, or can also be implemented by instructing the relevant hardware through programs. Programs can be stored in a computer-readable storage medium, which can be a read-only memory, a magnetic disk, an optical disc, or the like.

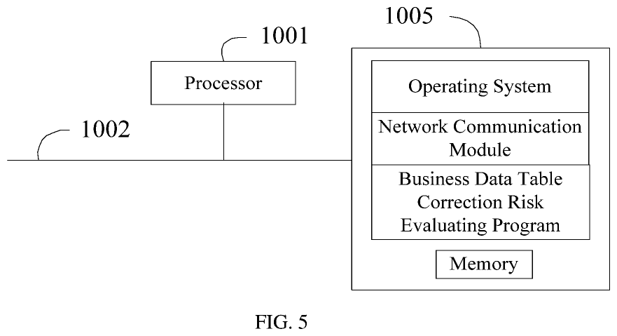

Referring now to FIG. 5, there is depicted a schematic diagram illustrating device structure in terms of hardware operating environment involved in the methods according to the embodiments of this disclosure.

In the embodiments according to this disclosure, the device for evaluating a risk of a business data table correction may be a personal computer (PC), or may also be a terminal device, such as a smart phone, a tablet computer, an e-book reader, an MP3 (Moving Picture Experts Group Audio Layer III) player, a MP4 (Moving Picture Experts Group Audio Layer IV) player, a portable computer, and so on.

As illustrated in FIG. 5, the device for evaluating a risk of a business data table correction may include a processor 1001 (e.g., a CPU), a memory 1005, and a communication bus 1002. The communication bus 1002 is configured to facilitate the connection and communication between the processor 1001 and the memory 1005. The memory 1005 may be a high-speed RAM memory, or a non-volatile memory such as a disk memory. The memory 1005 optionally may also be a storage device that is separate from the processor 1001 described above.

Optionally, the device for evaluating a risk of a business data table correction may further include a user interface, a network interface, a camera, an RF (Radio Frequency) circuitry, a sensor, an audio circuitry, a WiFi module, and the like. The user interface may include a display screen, an input unit such as a keyboard. The user interface may further optionally include a standard wired interface and wireless interface. The network interface may optionally include a standard wired interface, and a wireless interface (such as a Wi-Fi interface).

Those skilled in the art will appreciate that the structure of the device for evaluating a risk of a business data table correction as illustrated in FIG. 5 will not constitute a limitation on the device. Therefore, the device may include more or less components than those illustrated, or some components may be combined, or different arrangements of components may be employed.

As illustrated in FIG. 5, the memory 1005 as a computer storage medium may include an operating system, a network communication module, and a business data table correction risk evaluating program. The operating system is a program that manages and controls the hardware and software resources of the device for evaluating a risk of a business data table correction, and supports the operation of the business data table correction risk evaluating program and other software and/or programs. The network communication module is configured to facilitate the communication between components within the memory 1005, as well as the communication between the memory 1005 and other hardware and software in the device for evaluating a risk of a business data table correction.

In the device for evaluating a risk of a business data table correction as illustrated in FIG. 5, the processor 1001 is configured to execute the business data table correction risk evaluating program stored in the memory 1005 to perform the following operations: obtaining an original datum in a business data table, a corrected datum obtained by correcting the original datum, and a characteristic parameter of the corrected datum; converting the original datum, the corrected datum, and the characteristic parameter according to a preset conversion method to obtain a correction risk; and determining a risk level of the business data table correction based on the correction risk, and issuing a corresponding alert message according to the risk level.

Further, the block of “obtaining an original datum in a business data table, a corrected datum obtained by correcting the original datum, and a characteristic parameter of the corrected datum” includes the following operations: obtaining a currently corrected datum that results from a current corrective operation on the original datum, and a previously corrected datum that results from a previous corrective operation on the original datum; after the original datum is corrected as the currently corrected datum, obtaining a number of cells of cell data in the business data table that don't satisfy articulations; and obtaining a first parameter used to identify whether the currently corrected datum is to be delivered to a downstream system, a second parameter used to identify whether the currently corrected datum is a core data table datum, where the number of cells, the first parameter, and the second parameter are used as the characteristic parameters of the currently corrected datum.

Further, the block of “converting the original datum, the corrected datum, and the characteristic parameter according to a preset conversion method to obtain a correction risk” includes the following operations: obtaining a first differential datum between the currently corrected datum and the original datum and a second differential datum between the currently corrected datum and the previously corrected datum, and taking the first differential datum and the second differential datum as a differential coefficient; obtaining an adjustment coefficient for the differential coefficient based on the number of cells, the first parameter, and the second parameter; and obtaining the correction risk based on the differential coefficient and the adjustment coefficient.

Further, the block of “determining a risk level of the business data table correction based on the correction risk, and issuing a corresponding alert message according to the risk level” includes the following operations: determining the risk level of the business data table correction based on a value of the correction risk; and displaying the value of the correction risk correspondingly with the risk level of the business data table correction, and issuing an alert message corresponding to the risk level.

Further, the processor 1001 is configured to execute the business data table correction risk evaluating program stored in the memory 1005 to further perform the following operations subsequent to the block of “determining the risk level of the business data table correction based on a value of the correction risk”: determining whether the risk level exceeds a preset level; and when the risk level exceeds the preset level, skipping the operation of saving the currently corrected datum, and finding and notifying the reason why the risk level exceeds the preset level.

Further, the processor 1001 is configured to execute the business data table correction risk evaluating program stored in the memory 1005 to further perform the following operation subsequent to the block of “finding and notifying the reason why the risk level exceeds the preset level”: receiving a user entered first correction instruction based on the notified cause of the risk level exceeding the preset level, to correct the currently corrected datum.

Further, the processor 1001 is configured to execute the business data table correction risk evaluating program stored in the memory 1005 to further perform the following operation prior to the block of “obtaining an original datum in a business data table, a corrected datum obtained by correcting the original datum, and a characteristic parameter of the corrected datum”: extracting data from an upstream data table to create an interface data table, and converting the data in the interface data table into data conforming to the logic of the business data table according to a preset rule, to create the business data table.

Further, the processor 1001 is configured to execute the business data table correction risk evaluating program stored in the memory 1005 to further perform the following operations subsequent to the block of “converting the data in the interface data table into data conforming to the logic of the business data table according to a preset rule, to create the business data table”: determining whether there exists an erroneous datum in the business data table; and when there exists an erroneous datum, receiving a second correction instruction to correct the erroneous datum.

The specific implementations of the device for evaluating a risk of a business data table correction according to this disclosure are substantially the same as the foregoing various embodiments of the method for evaluating a risk of a business data table correction, and so they are not to be detailed herein.

This disclosure further provides a computer-readable storage medium having stored therein one or more programs, where the one or more programs can be executed by one or more processors to perform the following operations: obtaining an original datum in a business data table, a corrected datum obtained by correcting the original datum, and a characteristic parameter of the corrected datum; converting the original datum, the corrected datum, and the characteristic parameter according to a preset conversion method to obtain a correction risk; and determining a risk level of the business data table correction based on the correction risk, and issuing a corresponding alert message according to the risk level.

Further, the block of “obtaining an original datum in a business data table, a corrected datum obtained by correcting the original datum, and a characteristic parameter of the corrected datum” includes the following operations: obtaining a currently corrected datum that results from a current corrective operation on the original datum, and a previously corrected datum that results from a previous corrective operation on the original datum; obtaining a number of cells of cell data in the business data table that don't satisfy articulations, after the original datum is corrected as the currently corrected datum; and obtaining a first parameter used to identify whether the currently corrected datum is to be delivered to a downstream system, a second parameter used to identify whether the currently corrected datum is a core data table datum, wherein the number of cells, the first parameter, and the second parameter are used as the characteristic parameters of the currently corrected datum.

Further, the block of “converting the original datum, the corrected datum, and the characteristic parameter according to a preset conversion method to obtain a correction risk” includes the following operations: obtaining a first differential datum between the currently corrected datum and the original datum and a second differential datum between the currently corrected datum and the previously corrected datum, and taking the first differential datum and the second differential datum as a differential coefficient; obtaining an adjustment coefficient for the differential coefficient based on the number of cells, the first parameter, and the second parameter; and obtaining the correction risk based on the differential coefficient and the adjustment coefficient.

Further, the block of “determining a risk level of the business data table correction based on the correction risk, and issuing a corresponding alert message according to the risk level” includes the following operations: determining the risk level of the business data table correction based on a value of the correction risk; and displaying the value of the correction risk correspondingly with the risk level of the business data table correction, and issuing an alert message corresponding to the risk level.

Further, the one or more programs can be executed by the one or more processors to further perform the following operations subsequent to the block of “determining a risk level of the business data table correction based on a value of the correction risk”: determining whether the risk level exceeds a preset level; and when the risk level exceeds the preset level, skipping the operation of saving the currently corrected datum, and finding and notifying a cause of the risk level exceeding the preset level.

Further, the one or more programs can be executed by the one or more processors to further perform the following operation subsequent to the block of “finding and notifying the reason why the risk level exceeds the preset level”: receiving a user entered first correction instruction based on the notified cause of the risk level exceeding the preset level, to correct the currently corrected datum.

Further, the one or more programs can be executed by the processor to further perform the following operation prior to the block of “obtaining an original datum in a business data table, a corrected datum obtained by correcting the original datum, and a characteristic parameter of the corrected datum”: extracting data from an upstream data table to create an interface data table, and converting the data in the interface data table into data conforming to the logic of the business data table according to a preset rule, to create the business data table.

Further, the one or more programs can be executed by the one or more processors to further perform the following operations subsequent to the block of “extracting data from an upstream data table to create an interface data table, and converting the data in the interface data table into data conforming to the logic of the business data table according to a preset rule, to create the business data table”: determining whether there exists an erroneous datum in the business data table; and when there exists an erroneous datum, receiving a second correction instruction to correct the erroneous datum.

The specific implementations of the computer-readable storage medium according to this disclosure are substantially the same as the foregoing various embodiments of the method for evaluating a risk of a business data table correction, and so they are not to be detailed herein.

As used herein, the terms “including,” “comprising,” or any other variants thereof are intended to encompass a non-exclusive inclusion, so that processes, methods, articles, or devices that include a series of elements will include not only those elements, but also other elements that haven't been explicitly listed or those that are inherent in such processes, methods, articles, or devices. In the absence of additional restrictions, an element defined by the phrase as “including/comprising a . . . ” will not preclude the existence of additional such elements in the processes, methods, articles, or devices that include this element.

The foregoing numbering of embodiments of this disclosure is intended for illustrative purposes only, and is not meant to indicate the pros and cons of these embodiments.

By the foregoing description of the implementations, it will be evident to those skilled in the art that the methods according to the above embodiments can be implemented by means of software plus the necessary general-purpose hardware platform; of course they can also be implemented by hardware, but in many cases the former will be the more advantageous implementations. Based on such an understanding, the essential technical solution according to this disclosure, or the portion that contributes to the prior art may be embodied as software products. Computer software products can be stored in a storage medium (e.g., a ROM/RAM, a magnetic disk, an optical disc) as described above and may include multiple instructions that, when executed, can cause a terminal device (e.g., a mobile phone, a computer, a server, a network device, or the like), to execute the methods as described in the various embodiments of this disclosure.

The foregoing description merely portrays some exemplary embodiments according to this disclosure and is not intended to limit the patentable scope of this disclosure. Any equivalent structural or flow transformations that are made under the concept of this disclosure taking advantage of the present specification and the accompanying drawings and any direct or indirect applications of the present disclosure in other related technical fields shall all fall in the patentable scope of protection of this disclosure.

1. A method for evaluating a risk of a business data table correction, comprising:
obtaining an original datum in a business data table, a corrected datum obtained by correcting the original datum, and a characteristic parameter of the corrected datum;
converting the original datum, the corrected datum, and the characteristic parameter according to a preset conversion method to obtain a correction risk; and
determining a risk level of the business data table correction based on the correction risk, and issuing a corresponding alert message according to the risk level.

2. The method of claim 1, wherein the block of “obtaining an original datum in a business data table, a corrected datum obtained by correcting the original datum, and a characteristic parameter of the corrected datum” comprises:
obtaining a currently corrected datum that results from a current corrective operation on the original datum, and a previously corrected datum that results from a previous corrective operation on the original datum;
obtaining a number of cells of cell data in the business data table that don't satisfy articulations, after the original datum is corrected as the currently corrected datum; and
obtaining a first parameter used to identify whether the currently corrected datum is to be delivered to a downstream system, a second parameter used to identify whether the currently corrected datum is a core data table datum, wherein the number of cells, the first parameter, and the second parameter are used as the characteristic parameters of the currently corrected datum.

3. The method of claim 2, wherein the block of “converting the original datum, the corrected datum, and the characteristic parameter according to a preset conversion method to obtain a correction risk” comprises:
obtaining a first differential datum between the currently corrected datum and the original datum and a second differential datum between the currently corrected datum and the previously corrected datum, and taking the first differential datum and the second differential datum as a differential coefficient;
obtaining an adjustment coefficient for the differential coefficient based on the number of cells, the first parameter, and the second parameter; and
obtaining the correction risk based on the differential coefficient and the adjustment coefficient.

4. The method of claim 1, wherein the block of “determining a risk level of the business data table correction based on the correction risk, and issuing a corresponding alert message according to the risk level” comprises:
determining the risk level of the business data table correction based on a value of the correction risk; and
displaying the value of the correction risk correspondingly with the risk level of the business data table correction, and issuing an alert message corresponding to the risk level.

5. The method of claim 4, further comprising the following operations subsequent to the block of “determining the risk level of the business data table correction based on a value of the correction risk”:
determining whether the risk level exceeds a preset level; and
when the risk level exceeds the preset level, skipping the operation of saving the currently corrected datum, and finding and notifying a cause of the risk level exceeding the preset level.

6. The method of claim 5, further comprising the following operations subsequent to the block of “finding and notifying a cause of the risk level exceeding the preset level”:
receiving a user entered first correction instruction based on the notified cause of the risk level exceeding the preset level, to correct the currently corrected datum.

7. The method of claim 1, further comprising the following operations prior to the block of “obtaining an original datum in a business data table, a corrected datum obtained by correcting the original datum, and a characteristic parameter of the corrected datum”:
extracting data from an upstream data table to create an interface data table, and converting the data in the interface data table into data conforming to the logic of the business data table according to a preset rule, to create the business data table.

8. The method of claim 7, further comprising the following operations subsequent to the block of “converting the data in the interface data table into data conforming to the logic of the business data table according to a preset rule, to create the business data table”:
determining whether there exists an erroneous datum in the business data table; and
when there exists an erroneous datum, receiving a second correction instruction to correct the erroneous datum.

9. A device for evaluating a risk of a business data table correction, the device comprising a memory, a processor, a communication bus, and a business data table correction risk evaluating program stored in the memory, the communication bus being configured to implement connection and communication between the processor and the memory, the processor being configured to execute the business data table correction risk evaluating program to perform the following operations:
obtaining an original datum in a business data table, a corrected datum obtained by correcting the original datum, and a characteristic parameter of the corrected datum;
converting the original datum, the corrected datum, and the characteristic parameter according to a preset conversion method to obtain a correction risk; and
determining a risk level of the business data table correction based on the correction risk, and issuing a corresponding alert message according to the risk level.

10. The device of claim 9, wherein the block of “obtaining an original datum in a business data table, a corrected datum obtained by correcting the original datum, and a characteristic parameter of the corrected datum” comprises:
obtaining a currently corrected datum that results from a current corrective operation on the original datum, and a previously corrected datum that results from a previous corrective operation on the original datum;
obtaining a number of cells of cell data in the business data table that don't satisfy articulations, after the original datum is corrected as the currently corrected datum; and
obtaining a first parameter used to identify whether the currently corrected datum is to be delivered to a downstream system, a second parameter used to identify whether the currently corrected datum is a core data table datum, wherein the number of cells, the first parameter, and the second parameter are used as the characteristic parameters of the currently corrected datum.

11. The device of claim 10, wherein the block of “converting the original datum, the corrected datum, and the characteristic parameter according to a preset conversion method to obtain a correction risk” comprises:
obtaining a first differential datum between the currently corrected datum and the original datum and a second differential datum between the currently corrected datum and the previously corrected datum, and taking the first differential datum and the second differential datum as a differential coefficient;
obtaining an adjustment coefficient for the differential coefficient based on the number of cells, the first parameter, and the second parameter; and
obtaining the correction risk based on the differential coefficient and the adjustment coefficient.

12. The device of claim 1, wherein the block of “determining a risk level of the business data table correction based on the correction risk, and issuing a corresponding alert message according to the risk level” comprises:
determining the risk level of the business data table correction based on a value of the correction risk; and
displaying the value of the correction risk correspondingly with the risk level of the business data table correction, and issuing an alert message corresponding to the risk level.

13. The device of claim 12, wherein the processor is configured to execute the business data table correction risk evaluating program to further perform the following operations subsequent to the block of “determining the risk level of the business data table correction based on a value of the correction risk”:
determining whether the risk level exceeds a preset level; and
when the risk level exceeds the preset level, skipping the operation of saving the currently corrected datum, and finding and notifying a cause of the risk level exceeding the preset level.

14. The device of claim 13, wherein the processor is configured to execute the business data table correction risk evaluating program to further perform the following operations subsequent to the block of “finding and notifying a cause of the risk level exceeding the preset level”:
receiving a user entered first correction instruction based on the notified cause of the risk level exceeding the preset level, to correct the currently corrected datum.

15-16. (canceled)

17. A computer-readable storage medium, having stored therein a business data table correction risk evaluating program, which when executed by a processor performs the following operations:
obtaining an original datum in a business data table, a corrected datum obtained by correcting the original datum, and a characteristic parameter of the corrected datum;
converting the original datum, the corrected datum, and the characteristic parameter according to a preset conversion method to obtain a correction risk; and
determining a risk level of the business data table correction based on the correction risk, and issuing a corresponding alert message according to the risk level.

18. The computer-readable storage medium of claim 17, wherein the block of “obtaining an original datum in a business data table, a corrected datum obtained by correcting the original datum, and a characteristic parameter of the corrected datum” comprises:
obtaining a currently corrected datum that results from a current corrective operation on the original datum, and a previously corrected datum that results from a previous corrective operation on the original datum;
obtaining a number of cells of cell data in the business data table that don't satisfy articulations, after the original datum is corrected as the currently corrected datum; and
obtaining a first parameter used to identify whether the currently corrected datum is to be delivered to a downstream system, a second parameter used to identify whether the currently corrected datum is a core data table datum, wherein the number of cells, the first parameter, and the second parameter are used as the characteristic parameters of the currently corrected datum.

19. The computer-readable storage medium of claim 18, wherein the block of “converting the original datum, the corrected datum, and the characteristic parameter according to a preset conversion method to obtain a correction risk” comprises:
obtaining a first differential datum between the currently corrected datum and the original datum and a second differential datum between the currently corrected datum and the previously corrected datum, and taking the first differential datum and the second differential datum as a differential coefficient;
obtaining an adjustment coefficient for the differential coefficient based on the number of cells, the first parameter, and the second parameter; and
obtaining the correction risk based on the differential coefficient and the adjustment coefficient.

20. The computer-readable storage medium of claim 17, wherein the block of “determining a risk level of the business data table correction based on the correction risk, and issuing a corresponding alert message according to the risk level” comprises:
determining the risk level of the business data table correction based on a value of the correction risk; and
displaying the value of the correction risk correspondingly with the risk level of the business data table correction, and issuing an alert message corresponding to the risk level.

21. The computer-readable storage medium of claim 20, wherein the business data table correction risk evaluating program when executed by the processor further performs the following operations subsequent to the block of “determining the risk level of the business data table correction based on a value of the correction risk”:
determining whether the risk level exceeds a preset level; and
when the risk level exceeds the preset level, skipping the operation of saving the currently corrected datum, and finding and notifying a cause of the risk level exceeding the preset level.

22. The computer-readable storage medium of claim 21, wherein the business data table correction risk evaluating program when executed by the processor further performs the following operations subsequent to the block of “finding and notifying a cause of the risk level exceeding the preset level”:
receiving a user entered first correction instruction based on the notified cause of the risk level exceeding the preset level, to correct the currently corrected datum.

23-24. (canceled)
